(19) United States
(12) Patent Application Publication
(10) Pub. No.: US 2012/0308849 A1
(43) Pub. Date: Dec. 6, 2012

(54) BATTERY ASSEMBLY

(75) Inventors: Per-Ake Tortstensson, Hisings-Backa (SE); Magnus Torell, Stenungsund (SE)

(73) Assignee: ALELION BATTERIES AB, NODINGE (SE)

(21) Appl. No.: 13/577,222

(22) PCT Filed: Feb. 5, 2010
(86) PCT No.: PCT/SE2010/050140

§ 371 Date: Aug. 3, 2012

(51) Int. Cl. H01M 10/42; H01M 14/00

(52) U.S. Cl. 429/7

(57) ABSTRACT

The invention concerns a battery assembly (1), comprising: at least a first block (4) of rechargeable battery cell members (3) that are arranged side by side in at least one row and that are electrically configured in parallel, wherein each cell member (3) has a first and a second electrode terminal (24, 25); a printed circuit board (PCB) (10) provided with an electronic circuit (11) configured to monitor, control and/or balance said first block (4) of cell members (3); and interconnecting means (6, 7, 8, 17, 18, 20, 28) arranged to connect the first electrode terminals (24) electrically to each other and to the PCB (10). The invention is characterized in that the interconnecting means comprises a first supporting metal plate (6) that: extends along said at least one row of cell members (3); is mechanically fixed to the first block (4) of cell members (3); is electrically connected to the first electrode terminal (24) of each of the cell members (3) in the first block (4) of cell members; and that is mechanically fixed to the PCB (10) via a mechanical fixation that also provides an electric connection between the first metal plate (6) and the PCB (10). The invention also concerns a battery system comprising a plurality of battery assemblies of the above type.

### TECHNICAL FIELD

This invention relates to a battery assembly according to the preamble of claim 1. In particular, the invention relates to a rechargeable battery assembly for applications requiring a relatively high power, such as driving of vehicles. The invention also relates to a battery system comprising a plurality of battery assemblies.

### BACKGROUND OF THE INVENTION

Rechargeable batteries of the lithium-ion (Li-ion) or nickel-cadmium (NiCd) type, or similar, have become increasingly interesting as an energy source for driving vehicles (cars, golf-carts, motor-bikes etc.) and other devices, such as boat engines and cleaning machines, as well as for powering e.g. cellular network base stations (together with solar or wind power equipment) in remote areas.

In such applications several battery cells are connected in series and/or parallel in a battery pack or assembly such as to be capable of delivering the required power/current/voltage. Normally, a battery pack of this type includes a battery management system (BMS), i.e. electronic equipment for monitoring, controlling and/or balancing the cells and the battery pack.

Smaller battery packs for computers, camcorder and the like have been on the market for some years and are rather well developed. Larger battery packs, i.e. battery packs for driving e.g. vehicles, make use of larger and heavier battery cells and operate with higher currents (typically with a power output of at least around 100 W and a current exceeding 10 A). This leads to somewhat different challenges, for instance how the heat developed during use should be handled and how the pack should be physically designed for holding the cells and the associated electronics together.

Traditionally, larger battery packs of e.g. LI-ion battery cells make use of a strip of nickel (Ni) that is spot-welded to the poles or terminals of the cells and soldered, often via cables, to a printed circuit board (PCB) containing an electronic circuit for battery management. The Ni-strip is further often used to hold the pack together. The PCB is normally fastened in some way to the outside of the pack.

Although this traditional design is well established and generally applied it has some drawbacks in that the method of production is rather complicated and time-consuming, in that it is sometimes difficult to hold the cells in place properly using only the Ni-strip, and in that the electrical losses are relatively high.

### SUMMARY OF THE INVENTION

An object of this invention is to provide an battery assembly that is generally improved compared to conventional, larger battery assemblies. This object is achieved by the battery assembly defined by the technical features contained in independent claim 1. The dependent claims contain advantageous embodiments, further developments and variants of the invention.

The invention concerns a battery assembly, comprising: at least a first block of rechargeable battery cells that are arranged side by side in at least one row and that are electrically configured in parallel, wherein each cell has a first and a second electrode terminal; a printed circuit board (PCB) provided with an electronic circuit configured to monitor, control and/or balance said first block of cells; and interconnecting means arranged to connect the first electrode terminals electrically to each other and to the PCB.

The invention is characterized in that the interconnecting means comprises a first supporting metal plate that: extends along said at least one row of cells; is mechanically fixed to the first block of cells; is electrically connected to the first electrode terminal of each of the cells in the first block of cells; and that is mechanically fixed to the PCB via a mechanical fixation that also provides an electric connection between the first metal plate and the PCB.

Thus, in the inventive design the first metal plate functions both as a supporting means for holding the cell block in place as well as a rather massive electrical conductor. This conductor is in turn capable of, on the one hand, leading an electrical current with small electrical losses to and from the first electrode terminals of the cells in the block and, on the other hand, leading an electrical current directly to and from the electronic circuit provided on the PCB without having to conduct (or providing means for conducting) the current through additional components, such as cables and cable contacts, for connecting the plate and the PCB.

An advantageous effect achieved with this design is a reduction of the electrical losses due to the large conductor (compared to e.g. the conventional Ni-strips) and the direct electrical connection between the metal plate and the PCB. Another advantageous effect of this design is that it makes the manufacture more efficient since cables are not required. A further advantageous effect is the dual function (supporting-conducting) of the metal plate which, for instance, leads to a reduction in the number of components and thereby makes the manufacture more cost-effective.

In an embodiment of the invention the interconnecting means is arranged to connect the second electrode terminals electrically to each other and to the PCB, wherein the interconnecting means comprises a second supporting metal plate that: extends along said at least one row of cell members; is mechanically fixed to the first block of cell members; is electrically connected to the second electrode terminal of each of the cell members in the first block of cell members; and that is mechanically fixed to the PCB via a mechanical fixation that also provides an electric connection between the second metal plate and the PCB.

In a further embodiment of the invention the cell members have an elongated shape with the first electrode terminal positioned in one end and the second electrode terminal positioned in an opposite end, wherein the cell members are arranged such that the first electrode terminals form a row on one side of the block and such that the second electrode terminals form another row on an opposite side of block, wherein the first metal plate extends along with, and in the vicinity of, the row of first terminals and wherein the second metal plate extends along with, and in the vicinity of, the row of second terminals.

In a further embodiment of the invention it comprises a second block of cell members configured in parallel, wherein the first and second cell blocks are configured in series.

In a further embodiment of the invention the PCB is arranged such that one side of the PCB faces the first block of cell members and an opposite side of the PCB faces the second block of cell members.

In a further embodiment of the invention the PCB extends in a plane that is substantially in parallel with a longitudinal axis of the cell members.

In a further embodiment of the invention the first metal plate is fixed directly to the first electrode terminal.

In a further embodiment of the invention the first metal plate comprises one or several zones with reduced thickness, wherein the first metal plate is fixed to the first electrode terminal via such a zone.

In a further embodiment of the invention the first metal plate is fixed to the first electrode terminal via a Ni-strip.

In a further embodiment of the invention the first metal plate is provided with cut-outs positioned in relation to the first electrode terminals in such a way that the plate at least partly surrounds each of the terminals.

In a further embodiment of the invention the first metal plate is fixed to the first electrode terminal by means of spot-welding.

In a further embodiment of the invention the first metal plate is fixed to the Ni-strip by means of spot-welding.

In a further embodiment of the invention the first metal plate is made of a Cu-based alloy.

In a further embodiment of the invention the first metal plate is made of brass.

In a further embodiment of the invention the first metal plate contains 60-66% Cu.

In a further embodiment of the invention the first metal plate is made of Al or an Al-based alloy.

In a further embodiment of the invention the first supporting metal plate has a thickness of at least 0.5 mm.

In a further embodiment of the invention the cell members comprises a cell that is of a lithium-ion type.

In a further embodiment of the invention the fixation that connects the first supporting metal plate to the PCB comprises a screw joint or a press-fitting arrangement or a riveting arrangement.

The invention also concerns a battery system comprising a plurality of battery assemblies of the above type.

### BRIEF DESCRIPTION OF DRAWINGS

In the description of the invention given below reference is made to the following figure, in which:

FIG. 1 shows, in a perspective view, a first preferred embodiment of the inventive battery assembly,

FIG. 2 shows, in a partly sectional and partly transparent perspective view, the embodiment according to FIG. 1,

FIG. 3 shows, in an exploded view, the embodiment according to FIG. 1

FIG. 4 shows a block of cells forming part of the embodiment according to FIG. 1,

FIG. 5 shows, in a partly transparent view, the block of cells according to FIG. 5, and

FIG. 6 shows a supporting metal plate forming part of the embodiment according to FIG. 1.

### DESCRIPTION OF EXAMPLE EMBODIMENTS OF THE INVENTION

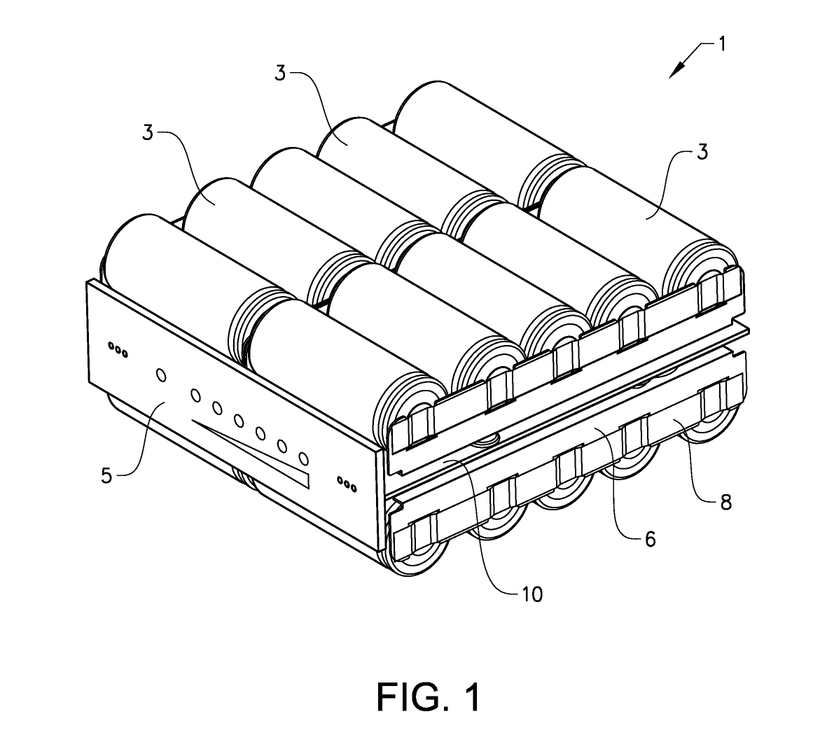

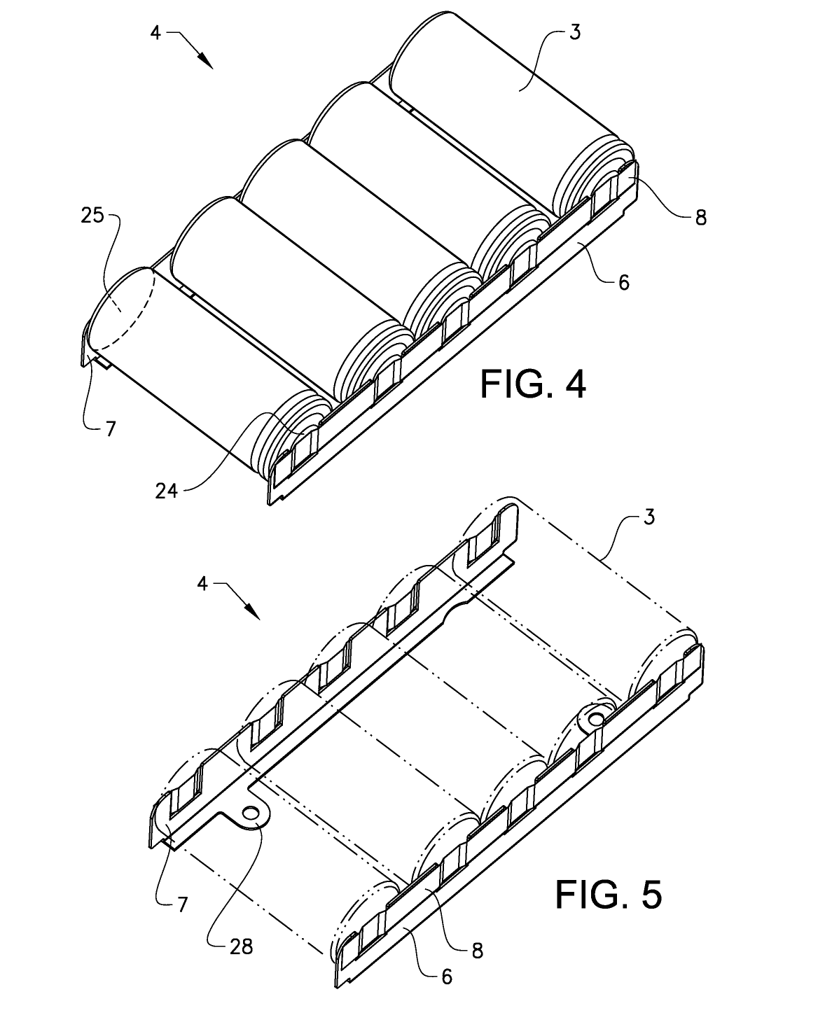

FIGS. 1-3 show a first preferred embodiment of a battery assembly 1 according to the invention. FIGS. 4-6 show details of the assembly 1.

In general, the battery assembly 1 comprises, in this example, four similar blocks 4 of rechargeable battery cells 3, a printed circuit board (PCB) 10 provided with an electronic circuit 11 (only schematically shown in the figures) configured to monitor and control the battery assembly 1 and to balance each of the cell blocks 4, and interconnecting means 6, 7, 8, 17, 18, 20, 28 arranged to electrically interconnect the individual cells 3 of each block 4 and to electrically connect the cell blocks 4 to the PCB 10.

Two cell blocks 4 are arranged on each side (i.e. on each main surface) of the PCB 10. Rigid, electrically conducting spacers 20, as well as resilient spacers 21, are arranged between the PCB 10 and the cell blocks 4 on an upper side (component side) of the PCB 10. Rigid, electrically conducting spacers 20 are also provided on a lower, opposite side (backside/non-component side) of the PCB 10. However, using spacers on the backside of the PCB 10 is optional. By arranging the PCB 10 in this way, the PCB 10 gets out of way while at the same time it becomes protected from external impacts. Moreover, the PCB 10 can, when arranged in this way, contribute to the stiffness and rigidity of the battery assembly 1, i.e. the PCB 10 has also a supporting function.

Each block 4 of cells comprises, in this example, five elongated, cylindrical cells 3 with a first electrode terminal 24 (e.g. anode terminal) arranged at one end (at one base area) and a second electrode terminal 25 (e.g. cathode terminal) arranged at the opposite end (at the opposite base area) (see FIG. 4). Each cell 3 has a circular cross-section (and base area). The curved cylindrical surface of each cell 3 is provided with an electrically insulating covering.

The cells 3 in each block 4 are arranged side by side in a row such that the first electrode terminals 24 of all cells 3 in the block 4 point in one and the same direction and the second electrode terminals 25 of all cells 3 in the block 4 point in an opposite direction.

The cells 3 within each block 4 are electrically configured in parallel, i.e. all first electrode terminals 24 of the cells in the block are electrically interconnected and all second electrode terminals 25 of the cells in the block are electrically interconnected.

The blocks 4 of cells are configured in series, i.e. the first electrode terminals 24 of a first cell block are electrically connected to the second electrode terminals 25 of a second cell block. This series connection goes via the PCB 10 which allows balancing etc. of each cell block and provides for a favourable conduction path.

The interconnecting means of the battery assembly 1 further comprises first and second metal plates 6, 7 that extend along opposite sides of the row of cells 3 in each cell block 4, wherein the first plate 6 has one side facing the first electrode terminals 24 of the cells 3 in a block of cells and wherein the second plate 7 has one side facing the second electrode terminals 25 of the cells 3 in the same block of cells (see FIGS. 4-5). The length of each metal plate 6, 7 is in this example approximately the same as the row of cells 3, whereas the width of each plate 6, 7 is around 75% of the cross-sectional diameter of the individual cells 3. The plates 6, 7 are arranged in the immediate vicinity of the cells 3, as seen in an axial or longitudinal direction of the cells 3. In this example the first and second plates 6, 7 are identical, but turned in opposite directions, and are made of brass and have a thickness of 0.7 mm.

The first metal plate 6 is fixed to the block 4 of cells 3 via a first mechanical fixation. In particular, the first plate 6 is electrically connected and mechanically fixed to the first electrode terminal 24 of each of the cells 3 in the block 4 by means of, in this example, a single Ni-strip 8 that extends along the plate 6 ant that is spot-welded onto each of the first electrode terminals 24 as well as to the first plate 6 (at both sides of the first electrode terminal 24).

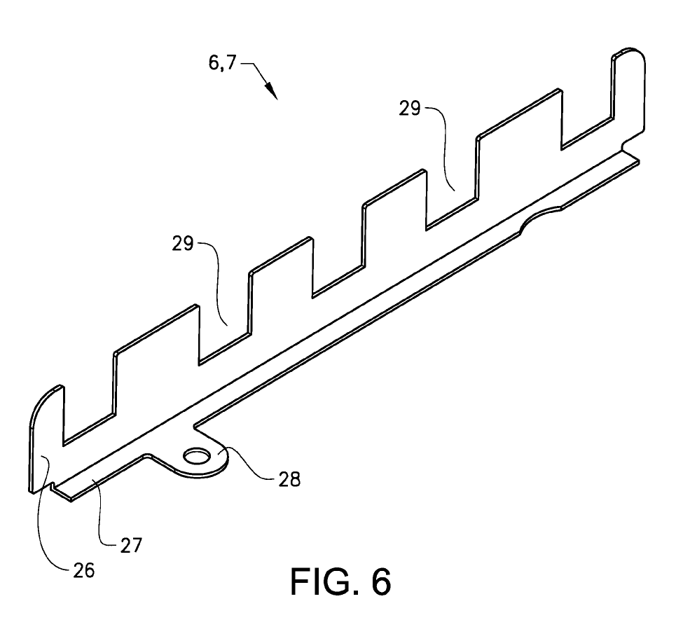

As can be clearly seen in FIG. 6 the plate 6 (7) is provided with cut-outs 29 in positions corresponding to that of each terminal 24 (when the plate 6 has been properly positioned in relation to the cell block 4). Thus, the cut-outs 29 provide access to the terminals 24 with the metal plate 6 surrounding the terminal 24 on, in this case, three sides thereof. This allows a single, straight Ni-strip 8 to be spot-welded onto the metal plate on each side of each of the cut-outs 29. This provides for an efficient manufacturing method, a high-strength mechanical fixation and a good electrical conduction between the first electrode terminal 24 and the metal plate 6 (via the spot-welds and the, compared to prior art, short Ni-strip).

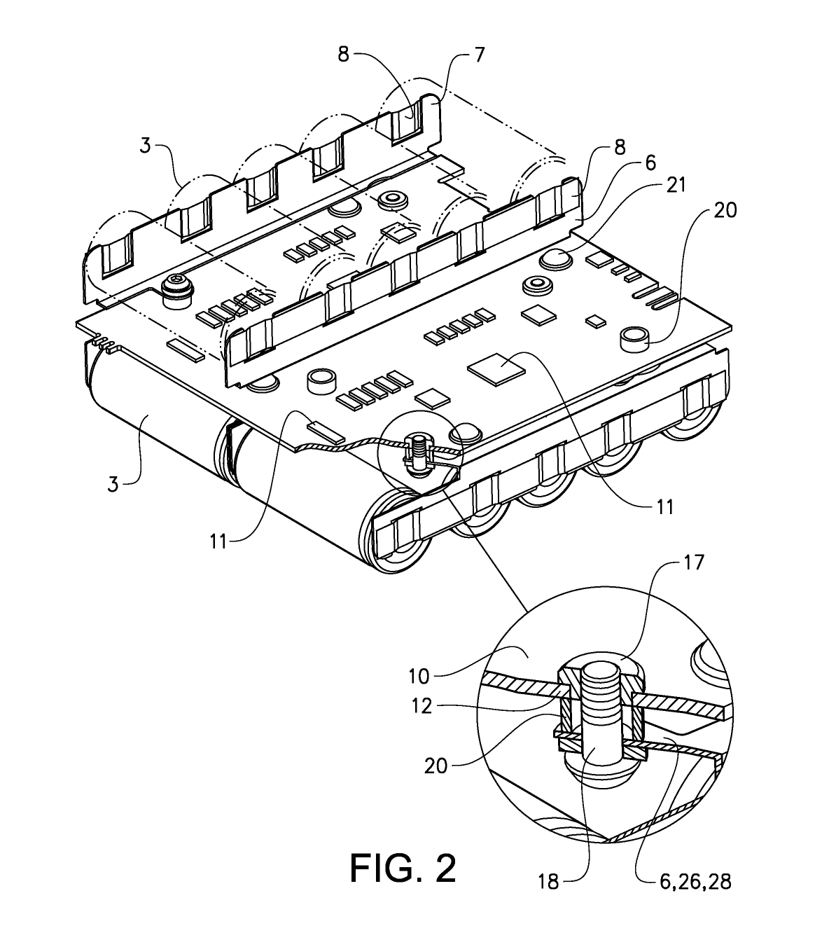

Further, the first metal plate 6 is mechanically fixed to the PCB 10 via a second mechanical fixation that also provides an electric connection between the first metal plate 6 and the PCB 10. As can be seen in FIG. 2 this second mechanical fixation comprises, in this example, a screw 18, an electrically conducting spacer 20 (optional), and a press-fit nut 17 pressed into the board 10 that fix the metal plate 6 (via spacer 20) to an electrically conducting area 12, such as a tinned copper pad, which area 12 is electrically connected to the electrical circuit 11 of the PCB 10. The area 12 can be designed in different ways and not explicitly indicated in FIG. 2. In a preferred variant, the area 12 includes a ring of conducting material around the screw hole on both sides of the PCB 10 as well as vertically arranged conducting material that connects the two rings. Current may flow through this conducting material and/or via the screw 18, the spacer 20 and the nut 17.

As can be seen in FIG. 6, the first plate 6 comprises a first portion 26 that extends along (and substantially in parallel to) the first electrode terminals 24, and to which portion the Ni-strip 8 is attached, and a second portion 27 that is substantially perpendicular to the first portion 26 and that extends somewhat in a longitudinal direction of the cells 3 at the side of the cells 3 facing the PCB 10. The second portion 27 comprises at least one attachment point 28 for fixing the plate 6 to the PCB 10. Thus, the first plate 6 exhibits, at least partly, an L-shaped cross section. This second portion 27 extends in the same plane as (i.e. in parallel to) the PCB 10 which simplifies the connection between the plate 6 and the PCB 10.

The second metal plate 7 is fixed to the block 4 of cells 3 and to the PCB 10 in a similar way as the first plate 6 and it is also designed in a similar way (cut-outs, first and second portions etc.).

A main function of arranging the metal plates 6, 7 as described above is that the electrical losses are reduced. Since each plate 6, 7 provides a large electric conductor from the connection to the Ni-strip 8 to the PCB 10 with a minimum of electrical losses, and since the length of the current conducting Ni-strip 10 is kept to minimum (i.e. the length between the spot-weld that connects the Ni-strip 8 to the terminal 24, 25 and the spot-weld that connects the Ni-strip 8 to the metal plate 6, 7), the total electrical losses are reduced compared to conventional battery assemblies where the current must be conducted a much longer distance through the Ni-strip and perhaps also must pass cable connections. Reduction of electrical losses increases in turn the efficiency of the battery assembly 1 including a reduction of the amount of heat generated during operation. Reduction of heat generation has a further advantage in that the lifetime of electrical components as well as battery cells is increased.

Ni typically has poor conductive properties so the length of any such strip should be kept to a minimum to reduce electrical losses.

Another main function of the metal plate arrangement is the mechanical/electrical fixation of the plate 6, 7 to the PCB 10 which makes it possible to avoid soldering. This simplifies and speeds up the manufacturing process of the battery assembly 1.

A further main function of the metal plate arrangement is that the rigid plates 6, 7, together with their firm fixation to both the cell block 4 and the PCB 10, provides for a battery assembly 1 that is hold together in an advantageous way and that make it easy and safe to handle. As mentioned above, also the PCB 10 contribute to the strength and rigidity of the assembly 1.

In the embodiment described above the brass used is ISO5150-4/CW508L which contains around 63% Cu and 37% Zn. Higher Cu-content leads to increased conductivity both with regard to electricity and temperature. High electrical conductivity is desired but if the Cu-content is too high welding becomes difficult because the increased capacity of conducting heat might result in that other (electronic) components becomes too hot and thereby destroyed during the welding process. The brass used provides a useful trade-off between sufficiently high electrical conductivity and sufficiently low thermal conductivity (for welding). For the embodiment described above, a suitable Cu-content of the first and second plates 6, 7 is around 60-66%.

In order to provide a sufficient strength and rigidity for its supporting function (i.e. for contributing significantly to the task of holding the cells in place), and in order to provide a sufficiently high capacity of conducting electricity, the plates 6, 7 should, in the example described, have a thickness of at least around 0.5 mm. Thicker plates, up to several mm, may be of interest for larger currents. The minimum thickness depends on the material and design of the plate as well as on the type, number and weight of the cells to support.

The exact design of the metal plate 6, 7 and Ni-strip 8 as well as e.g. the positions of the spot-weldings can be varied compared to what is described above. For instance, the cut-outs 29 may have a different shape and/or position in relation to the plate 6, 7 (they could e.g. form closed through-holes in the plates 6, 7). Further, instead of a single, longer Ni-strip 8 it is possible to make use of several short Ni-strips, e.g. one or two arranged at each terminal 24, 25. However, the above described arrangement, i.e. with open cut-outs 29 arranged at a side of the plate 6, 7 and with one single Ni-strip 8 extending along the row of cells 3, provides for a an efficient production process.

Besides thermal conductivity, plate thickness is of interest with regard to welding since the thicker the plate, the more heat will be conducted to other components during the welding process. Very thin plates (which may not be denoted plate but rather e.g. foil) are, however, not of interest because the capacity of conducting electricity will be too low and the supporting capability will also be reduced.

In a variant of the invention the first and/or second metal plate 6, 7 is spot-welded directly to the electrode terminals 24, 25. In this variant no Ni-strips 8 nor any plate cut-outs 29 are required. This way the electrical losses can be further reduced because the current no longer has to pass through any Ni-strip (even if the Ni-strip described above is relatively short) and because there is only one, instead of two, (spot-welded) contacts between the cell terminal 24, 25 and the metal plate 6, 7.

In order for such a metal plate to be sufficiently thick (for having a sufficient electrical conductivity) but at the same time allow welding (without destroying other components due to heat conduction during the welding process) the plate is preferably provided with zones having a smaller thickness. These zones are arranged in positions corresponding to that of each terminal (i.e. similar to the cut-outs 29 described above).

To allow for an efficient production of plates with varying thickness, such as extrusion, the plate preferably has a zone with decreased thickness that is not only present in positions corresponding to those of the terminals but that extends along the entire length of the plate. A cross section of such a plate does not change along the length of the plate and it can thus be extruded. The position, in relation to the sides of the plate, and the width of this thinner zone can be adapted to the particular application. Irrespective of the exact design of this thinner zone, such a plate is arranged to the block of cells in such a way that the thinner zone is contacted directly with each of the first (or second) electrode terminals 24, 25 of the cells 3 in the block 4.

An alternative material of the plates is aluminium. Other Al- or Cu-based alloys are also conceivable. Which material to use depends for instance on the material of the electrode terminals and the joining technique (e.g. welding or brazing).

The spot-welding of the Ni-strip 8 or metal plate 6, 7 to the electrode terminals 24, 25 mentioned above can in all variants and embodiments described in principle be replaced by e.g. a clamping arrangement or other joining techinque. However, spot-welding is a generally accepted method that normally provides for a reliable and firm electrical and mechanical connection. Further, a weaker electrical connection of the Ni-strip/metal plate to the terminals 24, 25 can be complemented with a further mechanical fixation that fixes the metal plate 6, 7 further to the block 4 of cells.

Also the connection between the metal plate 6, 7 and the PCB 10 can be arranged in other ways without employing soldering. An example is various forms of press-fitting. Soldering is also possible even if it normally is an advantage to avoid this technique when trying to make the manufacture process more effective.

The individual cells in the embodiments described above are Li-ion cells (LiFePO4-cells) of size-type 26650 (diameter 26 mm. length 65 mm) and with a voltage of 3.2 V and a capacity of 10 Wh. Other battery cells that are suitable for the battery assembly according to the invention are primarily other types of Li-ion cells, such as LCO and NMC, as well as e.g. NIMH-cells. The shape of the cells does not necessarily have to be circular cylinders.

The battery assembly 1 exemplified here, i.e. with four cell blocks 4 arranged in series and with five cells 3 in each block 4, has a voltage of 12.8 V and a capacity of 15 Ah (around 200 Wh). Higher capacities can be achieved by increasing the number of cells in the cell blocks. Several battery assemblies of the inventive type can be combined/connected such as to achieve a much higher capacity.

The PCB 10 is of standard type (thickness around 1.6 mm in the described example). The electronic circuit 11 for battery management can be arranged in different ways. Such PCB's and circuits, as well as how to arrange e.g. power cables to a battery assembly, are well known to the skilled person and are not further described here.

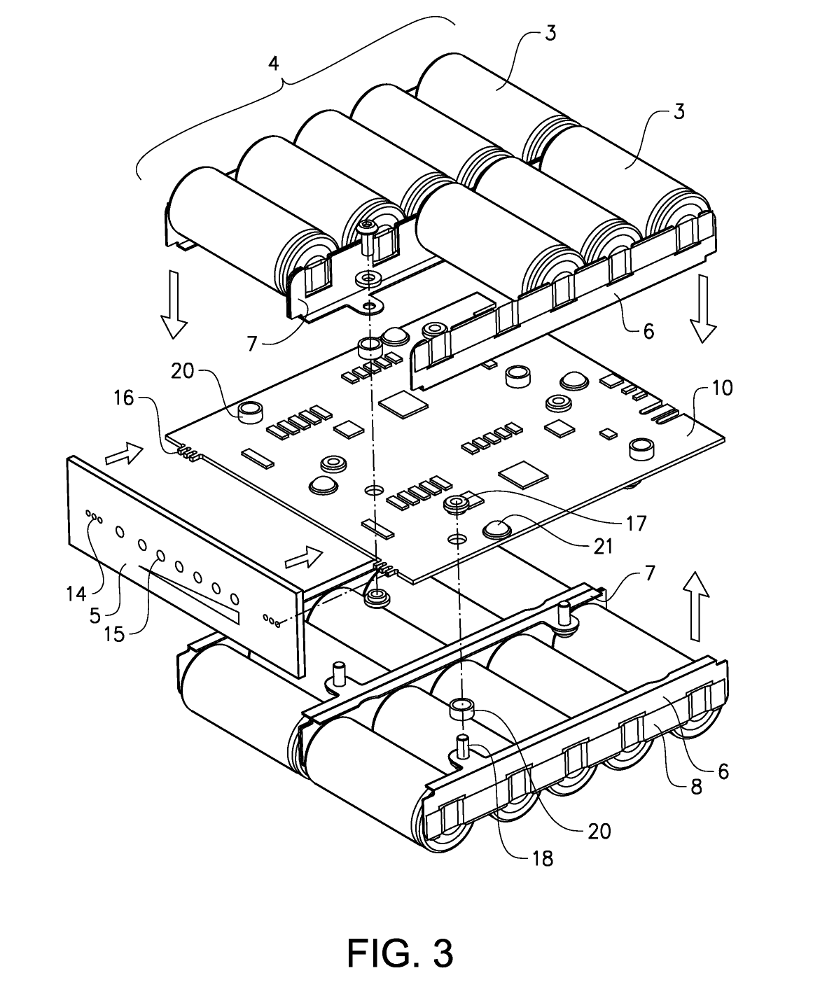

The battery assembly 1 further comprises a display means 5 for indicating the status of the assembly. The displays means 5 comprises two sets of first openings 14 for receiving corresponding protrusions 16 arranged at a side of and forming part of the PCB 10 (see FIG. 3). These openings 14 and protrusions 16 interact such as to provide a form of press-fitting. Display openings 15 in the display means 5 are arranged to show LEDs (not shown) arranged on the PCB 10 behind the display means 5.

The inventive battery assembly 1 enables a cost-effective production, allows handling of large currents and generates a minimum of electrical losses,

The invention allows conduction of the electricity from the different stages (blocks of cells) to the PCB by means of the interconnecting and fastening arrangement being used. Using this conductive method a conductor with a relatively high conductive area is provided all, or almost all, the way from the energy source (the electrode terminal) to the PCB.

The PCB 10, including its electronic circuit 11, has three major functions: Firstly, there is the cell balancing circuitery and also some intelligence that allows shutting the energy source off under certain circumstances. Secondly, the PCB is used as a big conductor to connect the stages (cell blocks) in serial to obtain the desired voltage, in this case 12V. Thirdly, it provides a supporting function to (it contributes to the rigidity of) the battery assembly due to the rigidity of the PCB 10 and the mechanical fixation of the metal plates 6, 7 to the PCB 10 and to the cell block 4.

The number of parallel cells in every stage (cell block) can be altered to obtain higher (or lower) energy content without changing the voltage. An increased number of parallel cells gives also a higher current capacity.

Several battery assemblies of the inventive type can be can be connected in series and/or parallel to obtain larger energy systems.

The battery assembly is prepared for a serial bus communication capable of communicating with governing systems, for instance regarding important battery conditions that might be required for a larger system.

Conventional battery assemblies of the type of concern here normally require an additional external supporting structure. Without such a structure, they become very delicate and difficult to handle, and larger energy sources (battery assemblies) may even be dangerous to handle.

The inventive solution makes a good building structure of mechanical components being used as electrical components as well, which makes it excel in mechanical strength, gives minimal electrical losses and as a bonus makes it very easy and safe to handle. The inventive battery assembly is rigid in itself and does not need any additional casing for supporting purposes. However, some form of (softer) enclosure that protects the cells from e.g. dirt and moisture and that prevents accidental contact with current conducting parts is recommended.

The invention is not limited by the embodiments described above but can be modified in various ways within the scope of the claims. For instance, more than one row of cells within the same cell block can be achieved by placing the cells in the same direction but on top of, or below, an existing row. Such a plurality of rows can be interconnected using a larger (wider) metal plate than shown in the figures.

Further, the individual cells described above may, at least in theory, contain two or more cells connected in series. The term cell member is intended to include such a variant.

The radial cross section of the cells does not necessarily have to be circular. Alternatively, it may be rounded or partly rounded without being circular (e.g. elliptical) or have a polygonal form (e.g. rectangular). Typically, cells with a rounded cross section are more difficult to hold in place than rectangular cells.

1. Battery assembly comprising:
at least a first block of rechargeable battery cell members that are arranged side by side in at least one row and that are electrically configured in parallel, wherein each cell member has a first and a second electrode terminal;
a printed circuit board (PCB) provided with an electronic circuit configured to monitor, control and/or balance said first block of cell members; and
interconnecting means arranged to connect the first electrode terminals electrically to each other and to the PCB, wherein the interconnecting means comprises a first supporting metal plate that:
extends along said at least one row of cell members;
is mechanically fixed to the first block of cell members;
is electrically connected to the first electrode terminal of each of the cell members in the first block of cell members; and
is mechanically fixed to the PCB via a mechanical fixation that also provides an electric connection between the first supporting metal plate and the PCB.

2. Battery assembly according to claim 1, wherein:
the interconnecting means is arranged to connect the second electrode terminals electrically to each other and to the PCB; and
the interconnecting means comprises a second supporting metal plate that:
extends along said at least one row of cell members;
is mechanically fixed to the first block of cell members;
is electrically connected to the second electrode terminal of each of the cell members in the first block of cell members; and that
is mechanically fixed to the PCB via a mechanical fixation that also provides an electric connection between the second supporting metal plate and the PCB.

3. Battery assembly according to claim 2, wherein:
the cell members have an elongated shape with the first electrode terminal positioned in one end and the second electrode terminal positioned in an opposite end;
the cell members are arranged such that the first electrode terminals form a row on one side of the block and such that the second electrode terminals form another row on an opposite side of block;
the first supporting metal plate extends along with, and in the vicinity of, the row of first terminals; and
the second supporting metal plate extends along with, and in the vicinity of, the row of second terminals.

4. Battery assembly according to claim 1, comprising a second block of cell members configured in parallel, wherein the first and second cell blocks are configured in series.

5. Battery assembly according to claim 4, wherein the PCB is arranged such that one side of the PCB faces the first block of cell members and an opposite side of the PCB faces the second block of cell members.

6. Battery assembly according to claim 3, wherein the PCB extends in a plane that is substantially in parallel with a longitudinal axis of the cell members.

7. Battery assembly according to claim 1, wherein the first supporting metal plate is fixed directly to the first electrode terminal.

8. Battery assembly according to claim 7, wherein the first supporting metal plate comprises one or several zones with reduced thickness, wherein the first supporting metal plate is fixed to the first electrode terminal via such a zone.

9. Battery assembly according to, claim 1 wherein the first supporting metal plate is fixed to the first electrode terminal via a Ni-strip.

10. Battery assembly according to claim 9, wherein the first supporting metal plate is provided with cut-outs positioned in relation to the first electrode terminals in such a way that the plate at least partly surrounds each of the terminals.

11. Battery assembly according to claim 7, wherein the first supporting metal plate is fixed to the first electrode terminal by means of spot-welding.

12. Battery assembly according to claim 9, wherein the first supporting metal plate is fixed to the Ni-strip by means of spot-welding.

13. Battery assembly according to claim 1, wherein the first supporting metal plate is made of a Cu-based alloy.

14. Battery assembly according to claim 13, wherein the first supporting metal plate is made of brass.

15. Battery assembly according to claim 1, wherein the first supporting metal plate contains 60-66% Cu.

16. Battery assembly according to, claim 1, wherein the first supporting metal plate is made of Al or an Al-based alloy.

17. Battery assembly according to claim 1, wherein the first supporting metal plate has a thickness of at least 0.5 mm.

18. Battery assembly according to claim 1, wherein the cell members comprises a cell that is of a lithium-ion type.

19. Battery assembly according to claim 1, wherein the mechanical fixation that connects the first supporting metal plate to the PCB comprises a screw joint, a press-fitting arrangement or a riveting arrangement.

20. (canceled)

21. A battery system comprising a plurality of battery assemblies, each assembly comprising:
at least a first block of rechargeable battery cell members that are arranged side by side in at least one row and that are electrically configured in parallel, wherein each cell member has a first and a second electrode terminal;
a printed circuit board (PCB) provided with an electronic circuit configured to monitor, control and/or balance said first block of cell members; and
interconnecting means arranged to connect the first electrode terminals electrically to each other and to the PCB, wherein the interconnecting means comprises a first supporting metal plate that extends along said at least one row of cell members, is mechanically fixed to the first block of cell members, is electrically connected to the first electrode terminal of each of the cell members in the first block of cell members, and is mechanically fixed to the PCB via a mechanical fixation that also provides an electric connection between the first supporting metal plate and the PCB.
